(19) United States
(12) Patent Application Publication
(10) Pub. No.: US 2010/0122951 A1
(43) Pub. Date: May 20, 2010

(54) PURIFICATION DEVICE FOR WATER

(76) Inventors: Victor Dulger, Heidelberg (DE); Ranjie Hou, Karlsruhe (DE)

Correspondence Address: Muncy, Geissler, Olds & Lowe, PLLC, P.O. BOX 1364, FAIRFAX, VA, 22038-1364, US

(21) Appl. No.: 12/620,039

(22) Filed: Nov. 17, 2009

Related U.S. Application Data
(60) Provisional application No. 61/115,725, filed on Nov. 18, 2008.

(30) Foreign Application Priority Data
Nov. 17, 2008 (EP) PCT/EP2008/009709

(51) Int. Cl. B01D 35/30

(52) U.S. Cl. 210/232

(57) ABSTRACT

A purification device for water is provided, which operates according to the principle of reverse osmosis and has a plurality of pipes essentially traveling in parallel, wherein first self-supporting common parts are provided, which have a plurality of recesses for force-fitting accommodation of the pipes and the common parts can be stacked one on top of the other. Through the formation of common parts, it is possible to erect large water treatment plants made from modules in a simple, cost-advantageous manner.

This nonprovisional application claims priority to PCT Application No. PCT/EP2008/009709, which was filed on Nov. 17, 2008, and to U.S. Provisional Application No. 61/115,725, which was filed on Nov. 18, 2008, and which are both herein incorporated by reference.

### BACKGROUND OF THE INVENTION

1. Field of the Invention

The present invention relates to a purification device for water.

2. Description of the Background Art

Purification devices for water that operate according to the principle of reverse osmosis have been known for many decades in the area of drinking water purification and are now widely used. They represent an important aid in the production of safe drinking water. In reverse osmosis, the water to be purified is forced at high pressure through an ultrafine membrane, wherein the membrane has little or no permeability for the undesirable substances. In addition to stationary purification devices, portable purification devices are also known.

For example, a portable purification device is disclosed in U.S. Pat. No. 5,788,858. The reverse osmosis unit consists of a plurality of pipes running horizontally in parallel, held by a metal frame. Plastic is generally used as the pipe material. To be able to use the purification device at various locations, the unit is mounted on a vehicle.

An additional purification device for water is known from EP 0 065 070 A2. The device disclosed includes a meandering pipeline. The pipe arcs are formed around a supporting frame constructed for this purpose. The pipes in the individual layers have a gradient so that the unit can be emptied easily.

To meet the increasing need for water, especially in desert regions, more and more large, stationary units for drinking water obtainment are being built, which have a plurality of layers made of essentially horizontal, parallel pipes and operate according to the reverse osmosis principle.

A disadvantage of the solutions to date is that in each case supporting frames, generally made of metal or even stainless steel, specifically adapted to the size of the purification devices, must be produced. The sizes of the supporting frames must be adapted to the local circumstances, wherein as a result of the large number of pipes fastened therein and their high weight, the supporting frame must have adequate stiffness or static load-bearing ability. Depending on the design of the supporting frame, various types of intermediate frames must be used for fastening the pipes or welded in a labor-intensive manner. The intermediate pieces must have adequate dimensional stability. Welding processes are generally used to adapt the supporting metal frames. In addition to meeting the static requirements, additional important prerequisites to be met for reliable operation are the dimensional stability and the requirements for corrosion resistance, especially in the case of seawater desalination units. Especially in the case of use in a corrosive environment, high-quality, expensive stainless steel is often used.

In addition to the extremely time-intensive construction of the supporting frames and the high material cost, additional high costs arise especially in the construction of large units. Furthermore, because of the requirements for quality and dimensional stability, individual construction is highly error-prone and can only be carried out by well-trained technical personnel such as welders, mechanics and metal fabricators.

### SUMMARY OF THE INVENTION

It is therefore an object of the present invention to provide a purification device for water which reduces the drawbacks of the state of the art.

According to an embodiment of the invention, a purification device for water that operates according to the principle of reverse osmosis and has a plurality of pipes essentially traveling in parallel is supplied, wherein first self-supporting common parts are provided, which have a plurality of cutouts for positive accommodation of the pipes, and the common parts can be stacked one on top of the other and a module with side pieces and intermediate pieces, wherein the first common parts are designed as intermediate pieces of the module and the side pieces can be connected to the intermediate pieces.

One advantage of the purification device according to the invention is that even large units can be assembled very rapidly at the location of use, in a cost-advantageous and simple manner. In particular, through the use of first self-supporting common parts, for the first time even large drinking water recovery units can be erected easily and reliably without expert personnel. Furthermore, such first common parts can be produced cost-advantageously on an industrial scale and can be transported in a space-saving, simple way.

In a further embodiment, two first common parts stacked one on top of the other form an opening for receiving at least one pipe. Since each of the first common parts has only one, preferably semi-circular, recess for accommodating the pipes, the static load-bearing capacity is only slightly impaired by the discontinuity of the form in the case of the first common parts. Furthermore, the introduction of the pipes, whose weight can amount to several hundred kilograms can be performed easily and rapidly by simply lowering them. Furthermore the size of the recess can be easily adapted to the diameter of the pipes during manufacturing, for example by means of a casting process, by modifying the molded parts used for manufacturing. In addition, by placing adapter pieces in the first common parts or around the respective pipe pieces, larger recesses may also be readily adapted to smaller pipe diameters retrospectively. Furthermore it is possible, especially when elastic materials are used as adapters, in addition to the force-fit connection, also to achieve a form-fit connection between the first common parts and the pipes. In this way the pipes embedded between the first common parts can be prevented from translational movement.

According to another embodiment, the first common parts, especially on their respective tops and bottoms, have molded pieces which fit together at least partially when stacked. Correspondingly the first common parts can be aligned relative to one another without further aid during stacking. Furthermore the first common parts are thereby protected against slipping sideways and the rigidity and self-supporting ability of the first common parts and the total purification device are increased.

In another embodiment, the first common parts can be connected with second common parts. It is also advantageous if for this purpose molded pieces are formed at the head ends of the first common parts to connect the first common parts with the second common parts at least partially in a form-fitting manner. Studies by the applicant have shown that it is advantageous to design the second common parts as side pieces which also have recesses to save weight. In this way it becomes possible in a simple fashion to prepare a module in which the first common parts are used as intermediate pieces and the second common parts as side pieces. Especially in the case of large units, the length of a pipe amounts to several meters and therefore it is preferred to support the pipes in several sections. Correspondingly it is provided, in order to avoid placing excessive stress on the pipes, generally made of plastic, that a module, in addition to two side pieces, can have three rows of intermediate pieces stacked one on top of the other between the side pieces. As a result of the molded pieces at the head ends of the first common parts, which for example are made in a swallow-tail design, and the second common parts having a corresponding accommodation, it is possible to quickly assemble the modules in a dimensionally stable manner on site without further aids.

According to another embodiment, it is advantageous to connect the second common parts with the first common parts using a fastener, for example, threaded rods, by means of which in the case of design of the second common parts as side pieces or in the case of design of the first common parts as intermediate pieces, the side pieces can be connected with the intermediate pieces in a force-fitting manner. To guarantee rapid assembly it is advantageous to provide suitable recesses in the first and second common parts, through which the fasteners can be easily introduced. By the use of suitable fasteners, among other things, the stability of the module can be increased substantially. Correspondingly it is also possible to prefabricate entire modules and transport the individual assembled modules to the site of use and there connect them rapidly and cost-advantageously into larger units without the previously customary steel beam construction. Furthermore the size of the units can be easily varied. Studies by the applicant have shown that it is advantageous to form the side pieces in a particularly rigid, statically loadable way. Through the fasteners and their force-locking connection possibility of the intermediate pieces with the side pieces, the large supporting forces of the pipes and the side walls can be at least partially transferred. In this way it also becomes possible to stack several modules one on top of the other without the lowermost pipe layer of the module below or their first common parts being excessively overloaded.

In a preferred further embodiment, third common parts are provided as spacers, which within one module make it possible to determine the distance between two opposite second common parts in advance without the first common parts already having to be used for this purpose. Preferably the third common parts at their respective head ends have molded pieces, for example in a swallow-tail design. In this way the third common parts can be easily introduced into corresponding recesses in the second common parts. It is also possible to design the third common parts or the spacers as supporting bodies to conduct the loads from the supported intermediate pieces to the side walls. It is especially advantageous if the spacers are introduced at least below the bottom layer of the first common parts. It is furthermore advantageous if the spacers can be connected with the side pieces by fastening means to transfer the large weight forces of the pieces lying on them into the third common parts.

In an embodiment, the first and/or second and/or third common parts are made of steel-reinforced concrete. In this case, by means of the inserted reinforcement, all types of common parts can be easily adapted to the necessary load-bearing ability. Furthermore the common parts can be prefabricated and easily transported to the site of use. It is also possible to produce the necessary common parts at the site of use. A further advantage is that the material is available almost anywhere and is cost-advantageous. A high corrosion resistance can be achieved simply and cost-advantageously through the use of steel reinforced concrete.

It should be mentioned that in the present invention the term “the common parts” designates the parts that fulfill a similar function, for example as side pieces or as intermediate pieces or as supporting pieces, preferably within a module. It is preferred for the common parts within the respective class of the first common parts, and within the class of the second common parts, and within the class of the third common parts and within the class of the fourth common parts to have both a similar external form and a different external form. In particular it is preferred that a side wall that is attached to a first side of a module should have a mirror-image shape in comparison to the side wall that is arranged on the second [side], opposite the first side of a module. In addition it is advantageous that especially in the case of the first common parts, each common part need not have a recess for receiving the first fastening means.

In a further embodiment, it is preferred to make the first and/or the second and/or the third common parts essentially of plastic or wood or a composite material, for example a glass fiber reinforced plastic.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a top view of first common parts of a purification device in accordance with an embodiment of the invention;

FIG. 2 is a perspective view of a module using third common parts as spacers;

FIG. 3 is a perspective view of the module of FIG. 2 with a first layer made of first common parts; and

FIG. 4 is a perspective view of an almost completely assembled module.

### DETAILED DESCRIPTION

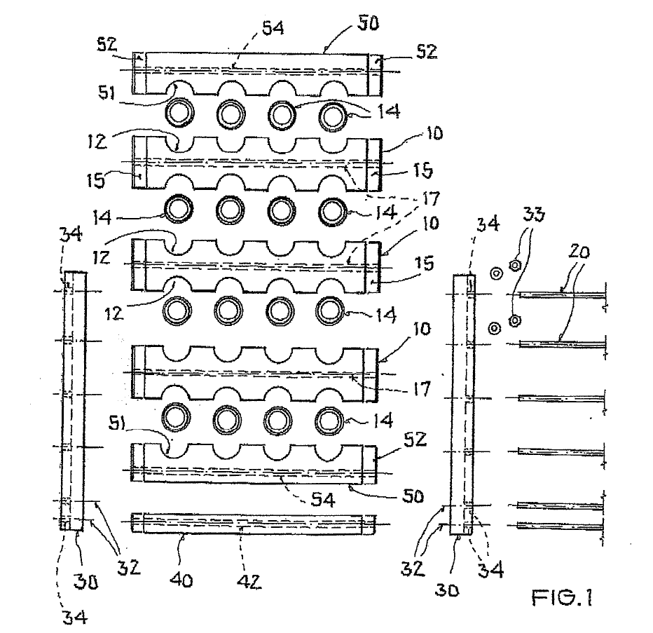

According to the illustration in FIG. 1, the purification device in accordance with the invention has first self-supporting common parts 10 with recesses 12 for accommodating pipes 14. On the respective head ends 15 of the first common parts 10, molded pieces, preferably in a swallow-tail design, are provided. Furthermore the first common parts 10 have cylindrical pass-through first recesses 17, into which first fastening means 20, preferably in the form of threaded rods, can be introduced. In addition the purification device in accordance with the invention has two common parts 30 designed as side pieces and third common parts 40 designed as spacers. Both the second common parts 30 and the third common parts 40 have cylindrical second recesses 32 or third recesses 42 for receiving part of the fastening means 20. Furthermore, in the second common parts 30, fourth recesses 34 are provided for receiving nuts 33. In this way the second common parts 30, designed as side pieces, can be aligned horizontally adjacent to one another with negligible space between them, even when first fastening means 20 are introduced. In addition, fourth common parts 50 are designed with recesses 51 and swallow-tail-shaped molded pieces on the respective head ends 52 for easily connecting the fourth common parts 50 with the second common parts 30. Furthermore the fourth common parts 50 have cylindrical, preferably penetrating fourth recesses 54. By means of the fourth common parts 50, a flat closing surface can be formed both on the underside of the stack consisting of first common parts 10 and on its top.

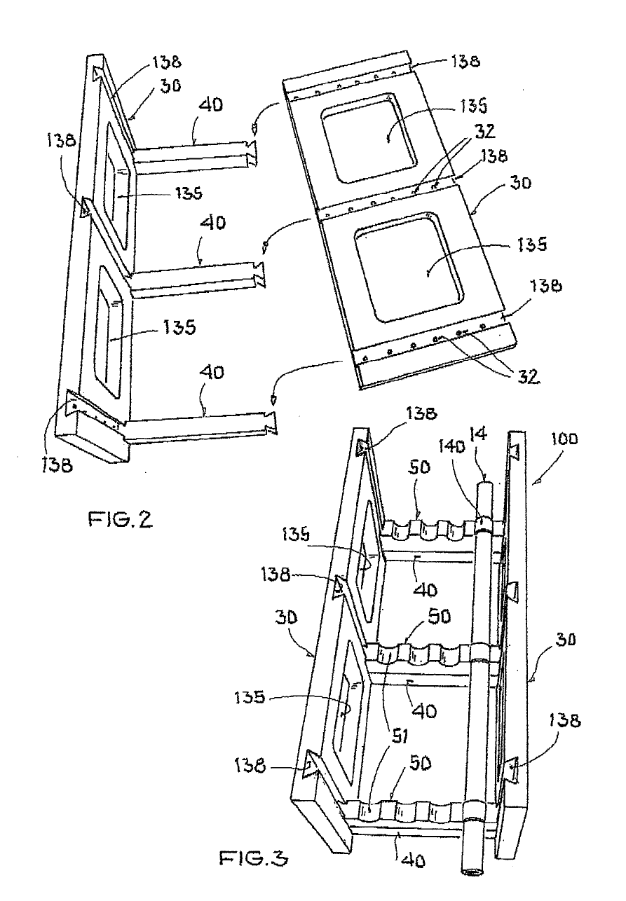

FIG. 2 and FIG. 3 respectively show a possible embodiment of a modular makeup or assembly of a module 100. According to the illustration in FIG. 2, a second side wall is placed in the third common part 30 already connected to a first side wall and designed as a spacer. To save weight, the second common parts 30 designed as side walls have fifth recesses 135. Furthermore the second common parts 30 preferably have guides 138 of swallow-tail design for optionally accommodating correspondingly shaped third and first common parts 30 and 10, respectively. In the introduced state, the open space between the side pieces shown is determined by the length of the spacers. Furthermore as a result of the distance of the guides 138 along a side piece, a grid dimension or a distance between the support points of the pipes is predetermined within the two side pieces.

According to FIG. 3 in the module 100 there are now fourth common parts 50 respectively supported on third common parts 40. Furthermore the assigned section of the pipe 14 lies in the third recesses 51 of the fourth common parts 50. In the embodiment shown the pipe 14 is surrounded with elastic sleeves 140 at the supporting sites to guarantee a form- and force-fitting connection between the pipes 14, when additionally first common parts 10 are slid into the guides 138.

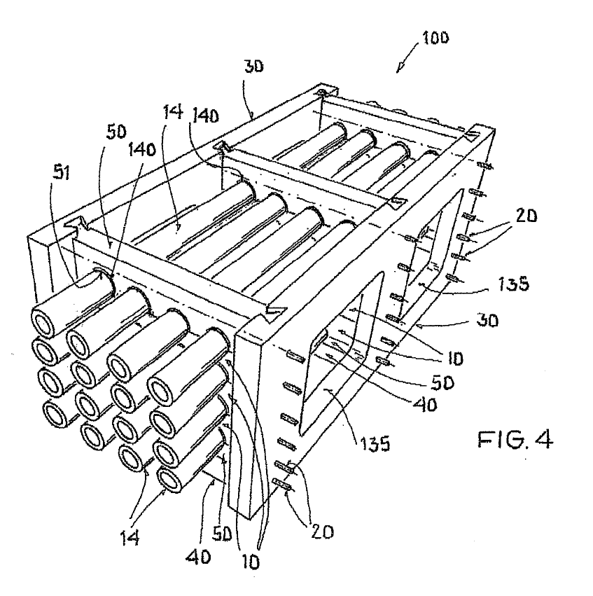

FIG. 4 shows a possible embodiment of a practically finished module 100 exhibiting a plurality of pipes 14 embedded between first common parts 10 and between first and fourth common parts 10 and 50 respectively. Furthermore, threaded rods are slid in as first fastening means 20 through the module 100 in order to secure the slid-in common parts against slipping when the module is lifted and to increase the stability of the modules by first diverting part of the weight of the stack to the side pieces.

One advantage of the embodiment shown is that through the use of common parts which additionally have advantageous recesses, easy and rapid assembly of the modules is made possible without requiring a large number of trained personnel. Furthermore, the modules can be transported to the site of use either as construction kits or in the finished state. In particular, modular construction with common parts, specifically in the case of large units for producing drinking water for example by seawater desalination, permits a considerable reduction of costs. In addition, the static calculations for the supporting frames, generally made of steel, which are particularly tedious to perform in the case of large units are no longer required. Likewise, tedious monitoring of the quality of weld seams and the dimensional stability of the frames can be dispensed with.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A purification device for water that operates according to principle of reverse osmosis, the purification device comprising:
a plurality of essentially parallel pipes;
first self-supporting common parts having a plurality of first recesses for force-fitting accommodation of the pipes and which represent first common parts that are stackable on top of one another; and
a module having side pieces and intermediate pieces,
wherein the first common parts are configured as intermediate pieces of the module and the side pieces are connectable to the intermediate pieces.

2. The purification device according to claim 1, wherein the side pieces are configured as two common parts.

3. The purification device according to claim 1, wherein the first common parts have molded pieces that at least partially interlock when stacked one on the other.

4. The purification device according to claim 3, wherein at head ends of the first common parts, molded pieces are formed so that the first common parts are connectable in an at least partially form-fitting way with the second common parts.

5. The purification device according to claim 2, wherein recesses are provided in the second common parts to reduce the weight.

6. The purification device according to claim 5, wherein the module has two side pieces and three rows of intermediate pieces stacked one on top of the other between the side pieces.

7. The purification device according to claim 5, wherein the side pieces are connectable with the intermediate pieces by a first fastener.

8. The purification device according to claim 6, wherein the side pieces and at least some of the intermediate pieces have recesses for accommodating the first fastener.

9. The purification device according to claim 6, wherein within the module three common parts are provided as spacers, which determine the distance between two second common parts located opposite one another.

10. The purification device according to claim 9, wherein the spacers are configured as supporting pieces to conduct the loads of supported intermediate pieces to the side walls.

11. The purification device according to claim 9, wherein the spacers are connectable with the side pieces by the first fastener.

12. The purification device according to claim 1, wherein the first common parts, and/or the second common parts, and/or the third common parts are made of steel reinforced concrete.

13. The purification device according to claim 1, wherein the first common parts, the second common parts and the third common parts are made of plastic.

14. The purification device according to claim 1, wherein the first common parts, the second common parts and the third common parts are made of wood.

15. The purification device according to claim 10, wherein the respectively first common parts and/or the respectively second common parts and/or the respectively third common parts have a different external form.
